(19) United States
(12) Patent Application Publication
(10) Pub. No.: US 2024/0370383 A1
(43) Pub. Date: Nov. 7, 2024

(54) METHOD AND SYSTEM TO PERFORM COMPLIANCE AND AVAILABILITY CHECK FOR INTERNET SMALL COMPUTER SYSTEM INTERFACE (ISCSI) SERVICE IN DISTRIBUTED STORAGE SYSTEM

(71) Applicant: VMware, Inc., Palo Alto, CA (US)

(72) Inventors: Sixuan YANG, Shanghai (CN); Yang YANG, Shanghai (CN); Zhaohui GUO, Shanghai (CN); Zhou HUANG, Shanghai (CN); Jian ZHAO, Shanghai (CN); Jianxiang ZHOU, Shanghai (CN); Jin FENG, Shanghai (CN)

(73) Assignee: VMware, Inc., Palo Alto, CA (US)

(21) Appl. No.: 18/141,995

(22) Filed: May 1, 2023

(51) Int. Cl. G06F 13/10

(52) U.S. Cl. CPC G06F 13/102; G06F 2213/0036

(57) ABSTRACT

One example method for a host in a virtual storage area network (vSAN) cluster to support vSAN Internet small computer system interface (iSCSI) target services in a distributed storage system of a virtualization system is disclosed. The method includes obtaining ownership information of a target and determining, from the ownership information, whether the host is an owner of the target. In response to determining that the host is the owner of the target, the method further includes determining whether the host commits to a policy provided by the vSAN to support the vSAN iSCSI target services. In response to determining that the host fails to commit to the policy, the method includes reporting a warning message.

### BACKGROUND

A virtualization software suite for implementing and managing virtual infrastructures in a virtualized computing environment may include (1) a hypervisor that implements virtual machines (VMs) on one or more physical hosts, (2) a virtual storage area network (e.g., vSAN) software that aggregates local storage to form a shared datastore for a vSAN cluster of hosts, and (3) a management server software that centrally provisions and manages virtual datacenters, VMs, hosts, clusters, datastores, and virtual networks. For illustration purposes only, one example of the vSAN may be VMware vSAN™. The vSAN software may be implemented as part of the hypervisor software.

The vSAN software uses the concept of a disk group as a container for solid-state drives (SSDs) and non-SSDs, such as hard disk drives (HDDs). On each host (node) in a vSAN cluster, local drives are organized into one or more disk groups. Each disk group includes one SSD that serves as a read cache and write buffer (e.g., a cache tier), and one or more SSDs or non-SSDs that serve as permanent storage (e.g., a capacity tier). The disk groups from all nodes in the vSAN cluster may be aggregated to form a vSAN datastore distributed and shared across the nodes in the vSAN cluster.

The vSAN software stores and manages data in the form of data containers called objects. An object is a logical volume that has its data and metadata distributed across the vSAN cluster. For example, every virtual machine disk (VMDK) is an object, as is every snapshot. For namespace objects, the vSAN software leverages virtual machine file system (VMFS) as the file system to store files within the namespace objects. A virtual machine (VM) is provisioned on a vSAN datastore as a VM home namespace object, which stores metadata files of the VM including descriptor files for the VM's VMDKs.

vSAN introduces a converged storage-compute platform where VMs are running on hosts as usual while a small percentage of CPU and memory resources is used to serve the storage needs of the same VMs. vSAN enables administrators to specify storage attributes, such as capacity, performance, and availability, in the form of one or more policies on a per-VM basis. vSAN offers many advantages over traditional storage, including scalability, simplicity, and lower total cost of ownership based on the policies.

Internet small computer system interface (iSCSI) is a transport layer protocol that describes how small computer system interface (SCSI) packets are transported over a transmission control protocol/Internet protocol (TCP/IP) network. vSAN iSCSI target (VIT) service allows hosts and physical workloads that reside outside a vSAN cluster to access a vSAN datastore of the vSAN cluster. VIT service enables an iSCSI initiator on a remote host to access block-level data of an iSCSI target in the vSAN cluster. After enabling and configuring VIT service on the vSAN cluster, a user can discover the iSCSI target from the remote host.

VIT service may also provide high availability (HA) and failures to tolerate (FTT) features based on policies provided by vSAN. However, hosts supporting the VIT service may be suffered from some issues which cause difficulties to provide these features.

### BRIEF DESCRIPTION OF THE DRAWINGS

FIG. 1 illustrates an example of a virtualization system that supports a virtual storage area network (vSAN) Internet small computer system interface (iSCSI) target service, in accordance with some embodiments of the present disclosure.

FIG. 2 is a simplified representation of a virtualization system that supports a vSAN iSCSI target service, in accordance with some embodiments of the present disclosure.

FIG. 3 illustrates a flowchart of example process for a host in a vSAN cluster to support a vSAN iSCSI target service, in accordance with some embodiments of the present disclosure.

FIG. 4 illustrates a flowchart of example process for a host in a vSAN cluster to support a vSAN iSCSI target service, in accordance with some embodiments of the present disclosure.

FIG. 5 is a block diagram of an illustrative embodiment of a computer program product for implementing the processes of FIG. 3 and FIG. 4, in accordance with some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated herein.

To support virtual storage area network (vSAN) Internet small computer system interface (ISCSI) target services, the following components are generally involved: (1) target, (2) distributed storage device, (3) discovery node (DN), and (4) storage node (SN).

A target can be a container for one or more distributed storage devices, which are typically identified using one or more logical unit numbers (LUNs). In some instances and throughout the following paragraphs, the term “LUN” can also refer to the distributed storage device itself. An initiator connects to a target via an owner of the target and then accesses the one or more LUNs in the target.

A DN is a host that can act as a discovery portal for vSAN iSCSI services that an initiator may access to discover available targets.

A SN is a host that can process iSCSI input/outputs (I/Os) to one or more LUNs within a target. Typically, a SN is also the owner of the target that the SN can access.

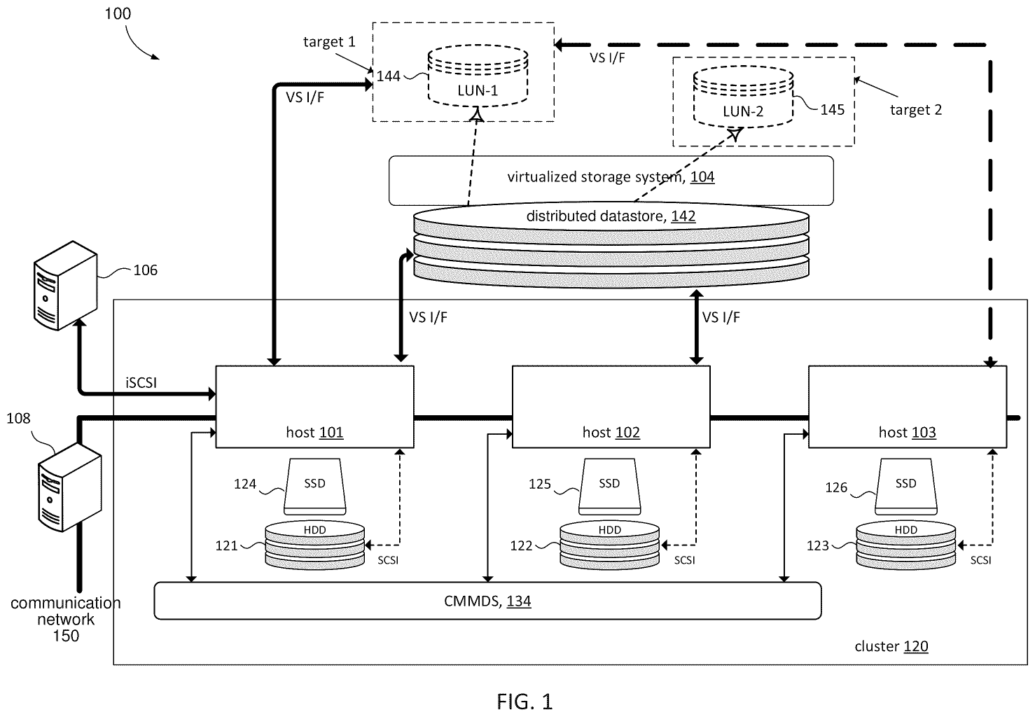

FIG. 1 illustrates an example of virtualization system 100 that supports vSAN iSCSI target service, in accordance with some embodiments of the present disclosure. Virtualization system 100 includes underlying hardware such as hosts 101, 102 and 103, a management entity 108 and communication network 150 (e.g., LAN, WAN, not shown) to interconnect host 101, 102, 103 and management entity 108. Hosts 101, 102 and 103 form vSAN cluster 120. Although FIG. 1 illustrates three hosts 101, 102 and 103 in cluster 120, it will be appreciated that cluster 120 may include additional (or fewer) hosts. Throughout this disclosure, the terms “host(s)” and “node(s)” are used interchangeably.

Host 101 may include one or more hard disk drives (HDDs) 121 connected to host 101. Similarly, hosts 102 and 103 also include HDDs 122 and 123 connected to hosts 102 and 103, respectively. In some embodiments, HDDs 121, 122 and 123 may be configured according to the SCSI (Small Computer System Interface) protocol, and hosts 101, 102 and 103 may communicate with HDDs 121, 122 and 123 using the SCSI protocol, respectively.

Hosts 101, 102 and 103 may also include solid state drive or disk (SSD) 124, 125 and 126, respectively. Any of hosts 101, 102 and 103 may be configured with a hypervisor (not shown for simplicity). The hypervisor may be a combination of computer software, firmware, and/or hardware that supports the execution of virtual machines (VMs) on hosts 101, 102 and 103.

Virtualization system 100 may include virtualized storage system 104 that provides virtual distributed datastore 142. Distributed datastore 142 may include an aggregation of HDDs 121, 122, 123 and SSDs 124, 125, 126. In some embodiments, HDDs 121, 122 and 123 may be used to provide persistent storage in distributed datastore 142, while SSDs 124, 125 and 126 may serve as read and write caches for data I/O operations. The VMs deployed on hosts 101, 102 and 103 may access distributed datastore 142 via a virtual storage interface (VS I/F) comprising commands and protocols defined by virtual storage system 104.

Virtualized storage system 104 may allocate storage from distributed datastore 142 to define distributed storage devices 144 and 145 (also referred to as virtual disks). Distributed storage devices 144 and 145 may include all or part of HDDs 121, 122 and 123 in cluster 120. In addition, HDDs 121, 122 and 123 may include SCSI-based storage devices that provide block-based storage of data. To illustrate, target 1 includes distributed storage device 144 corresponding to LUN-1 and target 2 includes distributed storage device 145 corresponding to LUN-2. LUN-1 and LUN-2 are shown to be supported by at all or part of HDDs 121, 122 and 123.

As an illustration, host 101 in FIG. 1 is both a DN and a SN. In some embodiments, virtualized storage system 104 is configured to provide HA and FTT features based on one or more policies. For illustration, assuming a policy is set to be FTT=1 (referring to that virtualized storage system 104 is configured to tolerate one failure for an initiator to access a target), virtualized storage system 104 may be configured to provide two owners for a target to commit to the policy FTT=1. For example, virtualized storage system 104 is configured to nominate host 101 as an active owner of target 1 and host 103 as a candidate owner of target 1.

More specifically, in some embodiments, initiator 106, which may be a computer system that is separate from the hosts in cluster 120, obtains the Internet Protocol (IP) address of host 101 and performs a login/authentication/target discovery sequence with host 101. After successfully completing the sequence and ensuring that host 101 is indeed the active owner of target 1, initiator 106 may then perform iSCSI-based Input/Output (I/O) operations to access LUN-1 144 in target 1 via host 101 as the active owner of target 1.

In scenarios that initiator 106 cannot successfully complete the login/authentication/target discovery sequence with host 101, initiator 106 may then obtains the IP address of host 103 (i.e., candidate owner of target 1) and performs the login/authentication/target discovery sequence with host 103 to try to perform iSCSI-based I/O operations to access LUN-1 144 in target 1 via host 103.

Virtualization system 100 may include additional infrastructure to support the vSAN iSCSI target service. In some embodiments, the infrastructure may include cluster monitoring membership and directory service (CMMDS) 134 which can distribute configurations or notifications in cluster 120. Each host may subscribe to CMMDS 134. In some embodiments, CMMDS 134 may have access to a datastore to maintain a list of subscribed hosts in cluster 120 and also owners of vSAN iSCSI targets. Any host in cluster 120 (e.g., host 101, 102 or 103) may announce changes of its configurations to cluster 120. CMMDS 134 may notify subscribed hosts of the changes. Configurations may include information relating to an iSCSI target, such as, without limitation, its LUNs, the size of the LUNs, the status of the LUNs (e.g., online and offline), its universally unique identifier (UUID), etc. In addition, an ownership of a target is also published in CMMDS 134. The published ownership includes both the active ownership to a specific target and the candidate ownership to the specific target. Therefore, the subscribed hosts (e.g., hosts 101, 102 and 103) in cluster 120 will learn which hosts in cluster 120 are the active owner and the candidate owner(s) of a specific target.

Virtualization system 100 may also include management entity 108 which provides management functionalities to various managed objects, such as cluster 120, hosts 101, 102, 103 and VMs on hosts 101, 102, 103. In addition, information may be transmitted among hosts 101, 102 and 103 and management entity 108 through communication network 150.

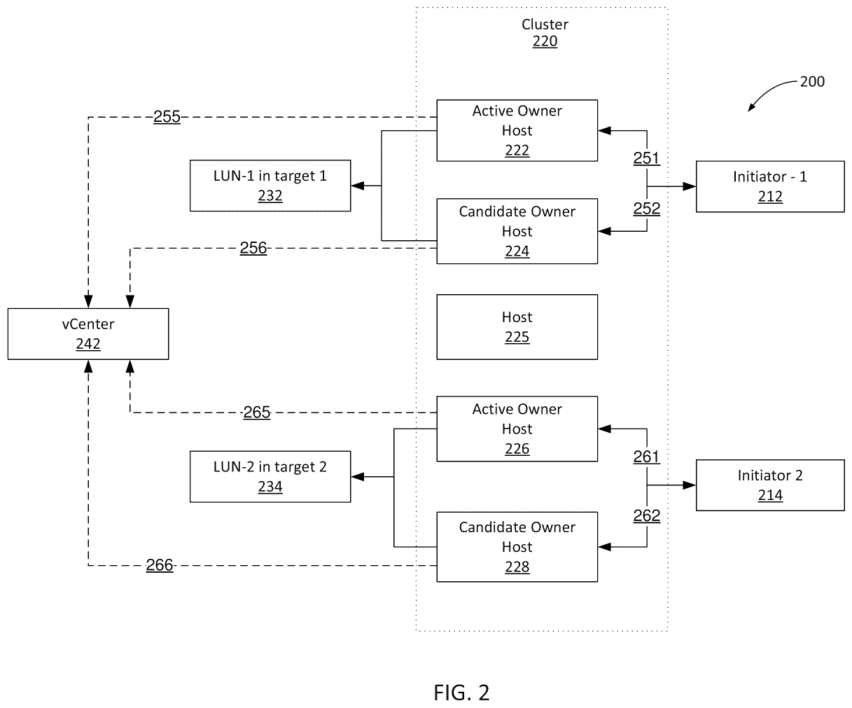

FIG. 2 is a simplified representation of a virtualization system 200 that supports vSAN iSCSI target service, in accordance with some embodiments of the present disclosure. In conjunction with FIG. 1, in some embodiments, virtualization system 200 corresponds to virtualization system 100; cluster 220 corresponds to cluster 120; and host 222, host 224 and host 225 correspond to hosts 101, 103 and 102, respectively. Although cluster 220 in FIG. 2 includes host 222, host 224, host 225, host 226 and host 228, cluster 220 may include more or fewer hosts. Virtualization system 200 may also include management entity 242 which provides management functionalities to various managed objects, such as cluster 220, hosts 222, 224, 225, 226 and 228 and VMs on these hosts. Virtualization system 200 also includes LUN-1 232 in target 1 and LUN-2 234 in target 2.

In some embodiments, to commit to a set policy of FTT=1, cluster 220 is configured to provide two owner hosts for a target. For example, host 222 is configured to be an active owner of target 1 and host 224 is configured to be a candidate owner of target 1. Similarly, host 226 is configured to be an active owner of target 2 and host 228 is configured to be a candidate owner of target 2.

In some embodiments, initiator-1 212 is configured to perform iSCSI-based I/O operations to access LUN-1 232 in target 1. Initiator-1 212 is configured to perform the operations via active owner host 222 via connection 251. Active owner host 222 is then configured to perform iSCSI-based I/O operations on LUN-1 232.

In some embodiments, host 224 is a candidate owner of target 1. As a candidate owner of target 1, to commit to the policy of FTT=1, host 224 is configured to perform iSCSI-based I/O operations on LUN-1 232 when the iSCSI-based I/O operations cannot be performed on LUN-1 232 via active owner host 222.

Similarly, initiator-2 214 is configured to perform iSCSI-based I/O operations to access LUN-2 234 in target 2. Initiator-2 214 is configured to perform the operations via active owner host 226 via connection 261. Active owner host 226 is then configured to perform iSCSI-based I/O operations on LUN-2 234. To commit to the policy of FTT=1, candidate owner host 228 is configured to perform iSCSI-based I/O operations on LUN-2 234 when the iSCSI-based I/O operations cannot be performed on LUN-2 234 via active owner host 226 to.

However, in some scenarios, candidate owner hosts 224 and 228 may fail to commit to the policy of FTT=1. For example, connections 252 and 262 may have network connection issues so that initiators 212 and 214 cannot connect to hosts 224 and 228, respectively. Therefore, initiators 212 and 214 cannot access LUN-1 232 and LUN-2 234 via hosts 224 and 228, respectively. In other scenarios, candidate owner hosts 224 and 228 may experience resource shortages (e.g., lacking computing resources) and cannot process iSCSI-based I/O operations on LUN-1 232 and LUN-2 234, respectively. Such network connection issues and resource shortages will cause failures to commit to the policy of FTT=1 in virtualized system 200 which results in errors or downgrades of the vSAN iSCSI target service.

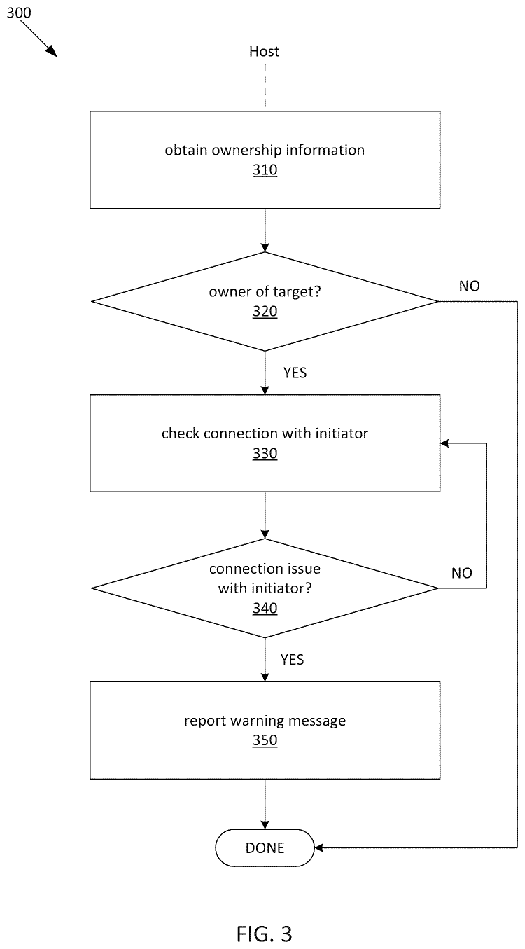

FIG. 3 illustrates a flowchart of example process 300 for a host in a vSAN cluster to support vSAN iSCSI target service, in accordance with some embodiments of the present disclosure. Example process 300 may include one or more operations, functions, or actions illustrated by one or more blocks, such as 310 to 350. The various blocks may be combined into fewer blocks, divided into additional blocks, and/or eliminated depending on the desired implementation.

Process 300 may begin with block 310 “obtain ownership information”. In some embodiments, in conjunction with FIG. 1, at block 310, hosts 101, 102 and 103 may subscribe CMMDS 134 for an event of an ownership change of a target. The ownership may include an active ownership of the target and one or more candidate ownership of the target. For illustration, host 101 is configured to obtain ownership information from CMMDS 134 indicating it is the active owner of target 1. Similarly, host 103 is configured to obtain ownership information from CMMDS 134 indicating it is the candidate owner of target 1. Host 102 is configured to obtain ownership information from CMMDS 134 indicating it is not an owner of a target. Process 300 may be followed by block 320 “owner of target?”.

In some embodiments, at block 320, a host is configured to determine whether the host itself is an active owner of a target or a candidate owner of a target based on ownership information obtained at block 310. If the host (e.g., host 102 in FIG. 1) determines the host itself not an active owner or a candidate owner of any target, process 300 ends. If the host (e.g., host 101 or 103 in FIG. 1) determines the host itself being an active owner or a candidate owner of any target, process 300 may be followed by block 330 “check connection with initiator.”

In some embodiments, at block 330, a host having an ownership to a target is configured to periodically check a network connection with an initiator to access the target. In conjunction with FIG. 2, host 222 is configured to periodically check status of connection 251 to initiator-1 212 and host 224 is also configured to periodically check status of connection 252 to initiator-1 212. Similarly, host 226 is configured to periodically check status of connection 261 to initiator-2 214 and host 228 is also configured to periodically check status of connection 262 to initiator-2 214. Process 300 may be followed by block 340 “connection issue with initiator?”

In some embodiments, as an active owner, at block 340, in conjunction with FIG. 2, in response to host 222 determining there is no connection issues with initiator-1 212, process 300 may be looped back to block 330. On the other hand, in response to host 222 determining these is a connection issue (e.g., network speed lower than a threshold or loss connection) with initiator-1 212, process 300 may be followed by block 350 “report warning message.” In some embodiments, the warning message includes, but not limited to, UUID of the LUN at issue (i.e., LUN-1), the IP address of the host at issue (i.e., host 222), the IP address of the initiator at issue (i.e., initiator-1 212) and network connection parameters of connection at issue (i.e., connection 251). At block 350, host 222 is configured to report a warning message associated with the connection issues to management entity 242 through connection 255. In some embodiments, management entity 242 is configured to manage cluster 220 to commit to policy of FTT=1 so that initiator-1 212 can access LUN-1 232 in target 1 via the candidate owner host 224 of target 1. In some embodiments, host 226 as an active owner host of target 2 will also perform similar operations of host 222.

In addition, as a candidate owner, at block 340, in conjunction with FIG. 2, in response to host 224 determining there is no connection issues with initiator-1 212, process 300 may be looped back to block 330. On the other hand, in response to host 224 determining these is a connection issue (e.g., network speed lower than a threshold or loss connection) with initiator-1 212, process 300 may be followed by block 350 “report warning message.” At block 350, host 224 is configured to report a warning message associated with the connection issues to management entity 242 through connection 256. In some embodiments, the warning message includes, but not limited to, UUID of the LUN at issue (i.e., LUN-1), the IP address of the host at issue (i.e., host 224), the IP address of the initiator at issue (i.e., initiator-1 212) and network connection parameters of connection at issue (i.e., connection 252). In some embodiments, management entity 242 is configured to manage cluster 220 to commit to the policy of FTT=1. Given host 224 fails to commit to the policy of FTT=1, host 224 is configured to update an ownership of target 1 through CMMDS to indicate that host 224 is no longer a candidate owner of target 1. Cluster 220 is then configured to nominate another host (e.g., host 225) in cluster 220 to be the candidate owner of target 1 and publish an event of ownership change of target 1 through CMMDS indicating host 225 is now a candidate owner of target 1. Host 225 is then configured to perform operations in process 300. In some embodiments, host 228 as a candidate owner host of target 2 will also perform similar operations of host 224. Cluster 220 is configured to monitor a connection between the newly candidate owner host 225 and initiator (i.e., initiator-1 212). In response to an issue of the monitored connection being detected, cluster 220 is configured to nominate another host to be the newly candidate owner host.

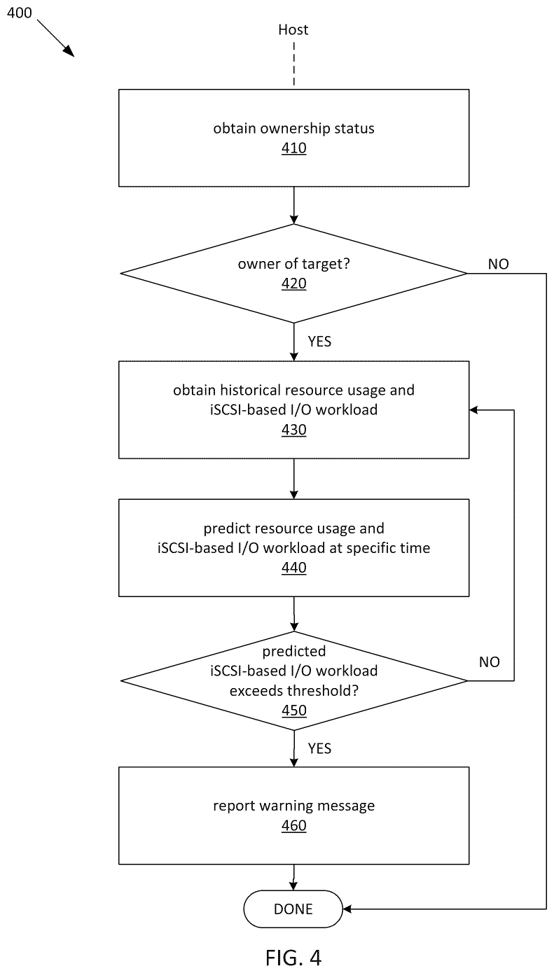

FIG. 4 illustrates a flowchart of example process 400 for a host in a vSAN cluster to support vSAN iSCSI target service, in accordance with some embodiments of the present disclosure. Example process 400 may include one or more operations, functions, or actions illustrated by one or more blocks, such as 410 to 460. The various blocks may be combined into fewer blocks, divided into additional blocks, and/or eliminated depending on the desired implementation. In conjunction with FIG. 1 and FIG. 2, in some embodiments, process 400 may also be performed by management entity 108 or 242.

Process 400 may begin with block 410 “obtain ownership information”. In some embodiments, in conjunction with FIG. 1, at block 410, hosts 101, 102 and 103 may subscribe CMMDS 134 for an event of an ownership change of a target. The ownership may include an active ownership of the target and one or more candidate ownership of the target. For illustration, host 101 is configured to obtain ownership information from CMMDS 134 indicating it is the active owner of target 1. Similarly, host 103 is configured to obtain ownership information from CMMDS 134 indicating it is the candidate owner of target 1. Host 102 is configured to obtain ownership information from CMMDS 134 indicating it is not an owner of a target. Process 400 may be followed by block 420 “owner of target?”.

In some embodiments, at block 420, a host is configured to determine whether the host itself is an active owner of a target or a candidate owner of a target based on ownership information obtained at block 410. If the host (e.g., host 102 in FIG. 1) determines the host itself not an active owner or a candidate owner of any target, process 400 ends. If the host (e.g., host 101 or 103 in FIG. 1) determines the host itself being an active owner or a candidate owner of any target, process 400 may be followed by block 430 “obtain historical resource usage and iSCSI-based I/O workload.”

At block 430, a host is configured to obtain historical resource usages and a iSCSI-based I/O workload in a previous time period. In some embodiments, a host having an ownership to a target is configured to obtain historical computation, memory and storage usages of the host in a previous time period (e.g., an hour preceding to the present point in time). In addition, the host is also configured to obtain its historical iSCSI-based I/O workload in the previous time period. For illustration only, assuming that historical CPU usage, the historical memory usage and the historical storage usage are 45%, 56% and 43%, respectively. In addition, the historical iSCSI-based I/O workload in the previous time period is 64%. Block 430 may be followed by block 440 “predict resource usage and iSCSI-based I/O workload at specific time.”

At block 440, the host is configured to predict resource usages of the host and a iSCSI-based I/O workload of the host in an upcoming time period. In some embodiments, the host is configured to use a model fitting approach to predict resource usages of the host and a iSCSI-based I/O workload of the host in an upcoming time period based on information obtained at block 430. In some embodiments, the model fitting approach includes, but not limited to, non-linear least-squares minimization and curve-fitting, Prophet modelling and long short-term memory approaches. In some embodiments, inputs of the model fitting approach includes, but not limited to, information obtained at block 430, a specified upcoming time period and a default iSCSI-based I/O workload threshold. In some embodiments, the capability of the host to process isCSI-based I/O operations will downgrade when the iSCSI-based I/O workload is more than the default iSCSI-based I/O workload threshold.

In some embodiments, outputs of the model fitting approach includes, but not limited to, a predicted CPU usage of the host in the upcoming time period, a predicted memory usage of the host in the upcoming time period, a predicted storage usage of the host in the upcoming time period and a predicted iSCSI-based I/O workload in the upcoming time period. Block 440 may be followed by block 450 “predicted iSCSI-based workload exceeds threshold?.”

At block 450, the host is configured to determine whether predicted iSCSI-based I/O workload at block 440 exceeds the default iSCSI-based I/O workload threshold. If the predicted iSCSI-based I/O workload does not exceed the default iSCSI-based I/O workload threshold, process 400 may calculate a first difference between the predicted usages at block 440 and actual CPU, memory and storage usages in the upcoming time period and a second difference between the predicted iSCSI-based I/O workload at block 440 and an actual iSCSI-based I/O workload in the upcoming time period based on the r-square score or the root mean square error score and update the default iSCSI-based I/O workload based on the differences. Process 400 may then loop back to block 430.

In some embodiments, if the predicted iSCSI-based I/O workload exceed the default iSCSI-based I/O workload threshold, process 400 may be followed by block 460. In some embodiments, in response to the predicted iSCSI-based I/O workload exceeding the default iSCSI-based I/O workload threshold, the host is configured to predict its capability to process isCSI-based I/O workloads will downgrade in the upcoming time period.

At block 460, in conjunction with FIG. 2, an active owner host 222 is configured to report a warning message associated with the iSCSI-based I/O workload issues to management entity 242 through connection 255. In some embodiments, management entity 242 is configured to manage cluster 220 to commit to policy of FTT=1 so that initiator-1 212 can access LUN-1 232 in target 1 via the candidate owner host 224 of target 1. In some embodiments, host 226 as an active owner host of target 2 will also perform similar operations of host 222.

In addition, as a candidate owner, at block 460, in conjunction with FIG. 2, in response to host 224 determining there are iSCSI-based I/O workload issues in the upcoming time period, host 224 is configured to report a warning message associated with the iSCSI-based I/O workload issues to management entity 242 through connection 256. In some embodiments, the warning message includes, but not limited to, UUID of the LUN at issue (i.e., LUN-1), the IP address of the host at issue (i.e., host 224), the IP address of the initiator at issue (i.e., initiator-1 212) and the predicted iSCSI-based I/O workload issues in the upcoming time period. In some embodiments, management entity 242 is configured to manage cluster 220 to commit to the policy of FTT=1. Given host 224 fails to commit to the policy of FTT=1, host 224 is configured to update an ownership of target 1 through CMMDS to indicate that host 224 is no longer a candidate owner of target 1. Cluster 220 is then configured to nominate another host (e.g., host 225) in cluster 220 to be the candidate owner of target 1 and publish an event of ownership change of target 1 through CMMDS indicating host 225 is now a candidate owner of target 1. Host 225 is then configured to perform operations in process 400. In some embodiments, host 228 as a candidate owner host of target 2 will also perform similar operations of host 224. Cluster 220 is configured to monitor resource usages and iSCSI-based I/O workload of the newly candidate owner host 225. In response to an issue associated with the resource usages and/or the iSCSI-based I/O workload being detected, cluster 220 is configured to nominate another host to be the newly candidate owner host.

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform process(es) described herein with reference to FIG. 1 to FIG. 4.

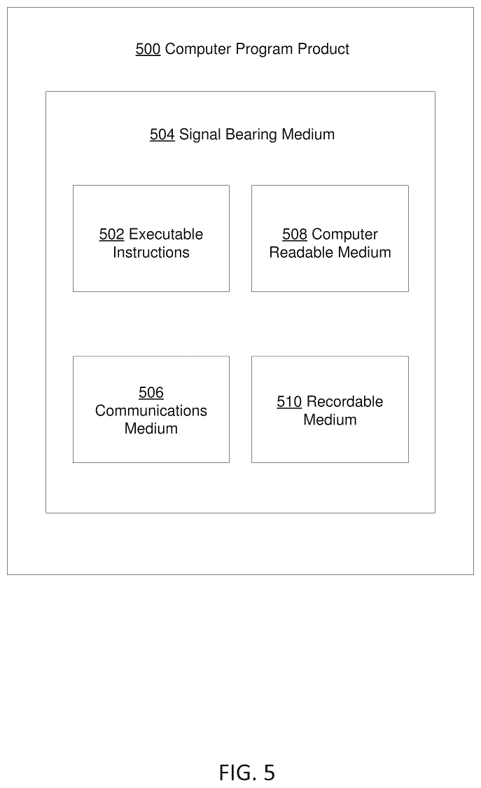

FIG. 5 is a block diagram of an illustrative embodiment of a computer program product 500 for implementing process 300 of FIG. 3 and process 400 of FIG. 4, in accordance with some embodiments of the present disclosure. Computer program product 500 may include a signal bearing medium 504. Signal bearing medium 504 may include one or more sets of executable instructions 502 that, in response to execution by, for example, one or more processors of hosts 101/102/103 of FIG. 1 and hosts 222/224/225/226/228 of FIG. 2, may provide at least the functionality described above with respect to FIG. 3 and FIG. 4.

In some implementations, signal bearing medium 504 may encompass a non-transitory computer readable medium 508, such as, but not limited to, a solid-state drive, a hard disk drive, a Compact Disc (CD), a Digital Video Disk (DVD), a digital tape, memory, etc. In some implementations, signal bearing medium 504 may encompass a recordable medium 510, such as, but not limited to, memory, read/write (R/W) CDs, R/W DVDs, etc. In some implementations, signal bearing medium 504 may encompass a communications medium 506, such as, but not limited to, a digital and/or an analog communication medium (e.g., a fiber optic cable, a waveguide, a wired communications link, a wireless communication link, etc.). Computer program product 500 may be recorded on non-transitory computer readable medium 508 or another similar recordable medium 510.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

1. A method for a host in a virtual storage area network (vSAN) cluster to support vSAN Internet small computer system interface (ISCSI) target services in a distributed storage system of a virtualization system, the method comprising:
obtaining ownership information of a target;
determining, from the ownership information, whether the host is an owner of the target;
in response to determining that the host is the owner of the target, determining whether the host commits to a policy provided by the vSAN to support the vSAN ISCSI target services; and
in response to determining that the host fails to commit to the policy, reporting a warning message.

2. The method of claim 1, wherein determining whether the host is the owner of the target further includes determining whether the host is an active owner or a candidate owner of the target.

3. The method of claim 2, wherein determining whether the host commits to the policy further includes:
checking a connection between the host and an initiator of the target; and
in response to determining that a connection issue exists between the host and the initiator, determining that the host fails to commit to the policy.

4. The method of claim 2, wherein determining whether the host commits to the policy further includes:
obtaining a historical resource usage of the host and a historical iSCSI-based Input/Output (I/O) workload on the host;
predicting a resource usage of the host and a iSCSI-based I/O workload on the host in a period of time; and
in response to determining that the upcoming iSCSI-based I/O workload exceeds a workload threshold, determining that the host fails to commit to the policy.

5. The method of claim 4, in response to determining that the upcoming iSCSI-based I/O workload does not exceed the workload threshold, further comprising:
calculating differences between the predicted resource usage and an actual resource usage of the host in the period of time and between the predicted iSCSI-based I/O workload and an actual iSCSI-based I/O workload in the period of time; and
adjusting the workload threshold based on the differences.

6. The method of claim 2, after determining that the host, as the candidate owner of the target, fails to commit to the policy, further comprising updating an ownership of the target to indicate that the host is no longer the owner of the target to cause the vSAN cluster to nominate another host to be a new candidate owner of the target.

7. The method of claim 2, after determining that the host, as the active owner of the target, fails to commit to the policy, further comprising updating an ownership of the target to indicate that the host is no longer the owner of the target to cause the vSAN cluster to use a candidate owner of the target to support the vSAN iSCSI target service.

8. A non-transitory computer-readable storage medium that includes a set of instructions which, in response to execution by a processor of a computer system, cause the processor to perform a method for a host in a virtual storage area network (vSAN) cluster to support vSAN Internet small computer system interface (iSCSI) target services in a distributed storage system of a virtualization system, the method comprising:
obtaining ownership information of a target;
determining whether the host is an owner of the target based on subscribed information from the vSAN cluster;
in response to determining that the host is the owner of the target, determining whether the host commits to a policy provided by the vSAN to support the vSAN ISCSI target services based on a connection associated with the iSCSI target services; and
in response to determining that the host fails to commit to the policy, reporting a warning message.

9. The non-transitory computer-readable storage medium of claim 8, wherein determining whether the host is the owner of the target further includes determining whether the host is an active owner or a candidate owner of the target.

10. The non-transitory computer-readable storage medium of claim 9, wherein the connection is a connection between the host and an initiator of the target.

11. The non-transitory computer-readable storage medium of claim 10, wherein determining whether the host commits to the policy further includes:
checking the connection; and
in response to determining that a connection issue exists between the host and the initiator, determining that the host fails to commit to the policy.

12. The non-transitory computer-readable storage medium of claim 9, wherein the non-transitory computer-readable storage medium includes additional instructions which, in response to execution by the processor, cause the processor to perform:
after determining that the host, as the candidate owner of the target, fails to commit to the policy, updating an ownership of the target to indicate that the host is no longer the owner of the target to cause the vSAN cluster to nominate another host to be a new candidate owner of the target.

13. The non-transitory computer-readable storage medium of claim 9, wherein the non-transitory computer-readable storage medium includes additional instructions which, in response to execution by the processor, cause the processor to perform:
after determining that the host, as the active owner of the target, fails to commit to the policy, updating an ownership of the target to indicate that the host is no longer the owner of the target to cause the vSAN cluster to use a candidate owner of the target to support the vSAN iSCSI target services.

14. A host in a virtual storage area network (vSAN) cluster to support vSAN Internet small computer system interface (ISCSI) target services in a distributed storage system of a virtualization system, comprising:
a processor; and
a non-transitory computer-readable medium having stored thereon instructions that, in response to execution by the processor, cause the processor to:
obtain ownership information of a target;
determine whether the host is an owner of the target based on subscribed information from the vSAN cluster;
in response to determining that the host is the owner of the target, determine whether the host commits to a policy provided by the vSAN to support the vSAN ISCSI target services based on resource usages of the host; and
in response to determining that the host fails to commit to the policy, report a warning message.

15. The host of claim 14, wherein the non-transitory computer-readable medium has stored thereon additional instructions that, in response to execution by the processor, cause the processor to determine whether the host is an active owner or a candidate owner of the target.

16. The host of claim 15, wherein the non-transitory computer-readable medium has stored thereon additional instructions that, in response to execution by the processor, cause the processor to:
obtain a historical resource usage of the host and a historical iSCSI-based Input/Output (I/O) workload on the host;
predict a resource usage of the host and a iSCSI-based I/O workload on the host in a period of time; and
in response to determining that the upcoming iSCSI-based I/O workload exceeds a workload threshold, determine that the host fails to commit to the policy.

17. The host of claim 16, wherein the non-transitory computer-readable medium has stored thereon additional instructions that, in response to execution by the processor, cause the processor to:
calculate a first difference between the predicted resource usage and an actual resource usage of the host in the period of time and a second difference between the predicted iSCSI-based I/O workload and an actual iSCSI-based I/O workload in the period of time; and
adjust the workload threshold based on the first difference and the second difference.

18. The host of claim 15, wherein the non-transitory computer-readable medium has stored thereon additional instructions that, in response to execution by the processor, cause the processor to:
after determining that the host, as the candidate owner of the target, fails to commit to the policy, update an ownership of the target to indicate that the host is no longer the owner of the target to cause the vSAN cluster to nominate another host to be a new candidate owner of the target.

19. The host of claim 15, wherein the non-transitory computer-readable medium has stored thereon additional instructions that, in response to execution by the processor, cause the processor to:
after determining that the host, as the active owner of the target, fails to commit to the policy, update an ownership of the target to indicate that the host is no longer the owner of the target to cause the vSAN cluster to use a candidate owner of the target to support the vSAN ISCSI target services.
